(19) United States
(12) Patent Application Publication
(10) Pub. No.: US 2022/0192237 A1
(43) Pub. Date: Jun. 23, 2022

(54) READY TO USE FOOD COMPOSITIONS AND A METHOD OF MAKING THE SAME

(71) Applicant: NUFLOWER FOODS AND NUTRITION PRIVATE LIMITED, New Delhi (IN)

(72) Inventors: Yaugita YADAV, Manesar (IN); Raja Raminder SINGH, Manesar (IN)

(73) Assignee: NUFLOWER FOODS AND NUTRITION PRIVATE LIMITED, New Delhi (IN)

(21) Appl. No.: 17/603,899

(22) PCT Filed: Apr. 15, 2020
(86) PCT No.: PCT/IN2020/050355

§ 371 Date: Oct. 14, 2021

(30) Foreign Application Priority Data
May 2, 2019 (IN) 201911017634

(51) Int. Cl. A23L 7/10; A23L 33/10; A23L 33/00

(52) U.S. Cl. CPC A23L 7/1975; A23L 33/40; A23L 33/10

(57) ABSTRACT

The present invention is a ready to use food composition comprising a mixture of at least one roasted cereal, a protein source, an oil blend, a milk product, sugar, a polysaccharide, a vitamin premix, a mineral premix and an emulsifier. The present invention further discloses a ready to use food composition comprising a mixture of a roasted oilseed, a roasted cereal, a cereal powder, a protein source, an oil blend, a milk product, sugar, a polysaccharide, a vitamin premix, a mineral premix and an emulsifier. The present invention further discloses a ready to use food composition comprising a mixture of a roasted legume, a roasted cereal, a protein source, an oil blend, a milk product, sugar, a polysaccharide, a vitamin premix, a mineral premix and an emulsifier.

### TECHNICAL FIELD

The present invention relates generally to food compositions in a ready-to-use form, and more particularly it relates to nutritious ready-to-use food compositions for people especially children affected with severe acute malnutrition (SAM).

### BACKGROUND

A ready-to-use food composition generally comprises a combination of supplements of nutrition including proteins, carbohydrates, fats, and sugar in order to provide an energy supplement to people especially children affected with severe acute malnutrition (SAM). Typically, a ready-to-use food product does not require additional preparation and can be consumed as is. These food products have a longer shelf life and can be easily consumed by malnourished people especially children. Also, these food products must have optimum nutrient density, so that it can be easily consumed and utilized by malnourished people especially children.

The existing ready-to-eat food formulations typically comprise a paste based on peanuts, milk product, or whey as a protein supplement. However, many people suffering from severe acute malnutrition (SAM) who live in developing countries, may not be able to afford the product as expensive ingredients and food supplements are used in the product which makes it very unaffordable. In addition, peanuts also suffer from a number of disadvantages. For example, peanuts contain common allergens, and have a poor mineral absorption. Hence, there is a need to provide a ready to use food composition that is peanut-free and yet nutritious, particularly to children affected with severe acute malnutrition (SAM).

It is therefore an object of the present invention to provide novel ready to use food compositions that can be made from locally available food ingredients and which are nutritious, healthy and tasty.

### SUMMARY

This section is provided to introduce certain aspects of the present invention in a simplified form that are further described below in the detailed description. This summary is not intended to identify the key features or the scope of the claimed subject matter.

In view of the afore-mentioned drawbacks and limitations of the prior art, it is an object of the present invention to provide nutritious ready-to-use food compositions for people especially children affected with severe acute malnutrition (SAM).

Another object of the invention is to provide a viable substitute to the peanut based ready-to-use food supplement and a method of making the same.

Yet another object of the invention is to provide non peanut based ready-to-use food compositions and a method of making the same.

Yet another object of the invention is to provide ready-to-use food compositions and a method thereof that has reduced sugar quantity and that provides better glycemic index.

Yet another object of the invention is to provide ready-to-use food compositions and a method thereof that relies upon a variety of formulations and use of local ingredients for rendering better acceptability by children.

Yet another object of the invention is to provide ready-to-use food compositions and a method thereof that contains macro & micro nutrients complying with UNICEF and WHO specifications.

In view of these and other objects, the present invention relates to a ready-to-use food composition comprising a mixture of at least one roasted cereal, a protein source, an oil blend, a milk product, sugar, a polysaccharide, a vitamin premix, a mineral premix and an emulsifier.

In an embodiment, the invention provides a ready-to-use food composition wherein the mixture comprises roasted wheat flour, roasted semolina, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to-use food composition, wherein the mixture comprises:
Roasted Wheat Flour: 10 to 20% by wt.;
Roasted Semolina: 4 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

The invention also discloses a ready-to-use food composition comprising a mixture of a roasted oilseed, a roasted cereal, a cereal powder, a protein source, an oil blend, a milk product, sugar, a polysaccharide, a vitamin premix, a mineral premix and an emulsifier.

In an embodiment, the invention provides a ready-to-use food composition wherein the mixture comprises roasted sesame seeds, roasted millets, malt powder, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to-use food composition, wherein the mixture comprises:
Roasted Sesame Seeds: 5 to 15% by wt.;
Roasted Millets: 5 to 15% by wt.;
Malt Powder: 2 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

The invention further discloses a ready-to-use food composition comprising a mixture of a roasted legume, a roasted cereal, a protein source, an oil blend, a milk product, sugar, a polysaccharide, a vitamin premix, a mineral premix and an emulsifier.

In an embodiment, the invention provides a ready-to-use food composition wherein the mixture comprises roasted pea, roasted corn flour, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to-use food composition wherein the mixture comprises:
Roasted Pea: 10 to 25% by wt.;
Roasted Corn Flour: 4 to 10% by wt.;
Malt Powder: 2 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

In an embodiment, the chemical and nutritional composition per 100 g of the food composition contains:
Moisture content: 2.5% maximum
Water activity: 0.6 maximum
Energy: 520-550 kcal
Proteins: 10-12% total energy and 12.8-16.2% by weight
Lipids: 45-60% total energy and 25.8-36.3% by weight
n-6 fatty acids: 3-10% total energy
n-3 fatty acids: 0.3-2.5% total energy
Trans-fatty acids: <3% total fat
Fibre: <5%
Free sugar: <15%;

Minerals including Sodium 290 mg maximum, Potassium 1100-1400 mg, Calcium 300-600 mg, Phosphorous 300-600 mg, Magnesium 80-140 mg, Iron 10-14 mg, Zinc 11-14 mg, Copper 1.4-1.8 mg, Selenium: 20-40 mcg, and Iodine 70-140 mcg;

Vitamins including Vitamin A (Retinol Equivalent) 0.8-1.1 mg, Vitamin B1(Thiamine) 0.5 mg minimum, Vitamin B2(Riboflavin) 1.6 mg minimum, Vitamin B3(Niacin) 5 mg minimum, Vitamin B5(Pantothenic acid) 3 mg minimum, Vitamin B6(Pyridoxine) 0.6 mg minimum, Vitamin B7(Biotin) 60 mcg minimum, Vitamin B9(Folic acid) 200 mcg minimum, Vitamin B12(Cyanocobalamin): 1.6 mcg minimum, Vitamin C(Ascorbic acid) 50 mg minimum; Vitamin D(Cholecalciferol): 15-20 mcg; Vitamin E(Tocopherol): 20 mg minimum; Vitamin K(Phytonadione): 15-30 mcg.

### DETAILED DESCRIPTION

In the following description, for the purposes of explanation, various specific details are set forth in order to provide a thorough understanding of the present invention. It will be apparent, however, that the present invention may be practiced without these specific details. Several features described hereafter can each be used independently of one another or with any combination of other features. An individual feature may not address any of the problems discussed above or might address only one of the problems discussed above.

The present invention provides nutritious ready-to-use food compositions and a method of making the same, wherein the ready-to-use food compositions are meant for people especially children affected with severe acute malnutrition (SAM). The present invention is a viable substitute to the peanut based ready-to-use food compositions available in the market. Further, the ready-to-use food composition as disclosed herein is based on a non-peanut based formulae wherein the sugar quantity is reduced for better glycemic index. Also, a variety of formulations and use of local ingredients has been incorporated in order to render better acceptability by people especially children. The disclosed ready-to-eat food compositions contain macro and micro nutrients that are complying to the UNICEF/WHO specifications and standards.

According to the present invention, the ready-to-use food compositions disclosed herein, are preferably provided to people especially children affected from severe acute malnutrition (SAM). The food compositions are non-peanut based and are manufactured by using local and easily available ingredients or staple foods.

An advantage of the present invention as disclosed herein, is that the invention provides a safeguard from any unwanted event, for example, peanut shortages or price bumping. The present invention uses cheaper ingredients such as cereals, legumes, oilseeds etc. for developing food compositions since products containing peanuts are expensive.

The ready-to-use food compositions disclosed in the present invention are smooth and homogeneous pastes that are easy to squeeze out of a sachet or tube. The ready-to-use food compositions do not elicit chewing when consumed by the target population and have minimal oil separation from the paste matrix. The ready-to-use food compositions disclosed herein, has a pleasing odour and a fresh flavour. Further, they are made free from foreign odours and flavours such as, (but not limited to) burnt, scorched, rancid, malted, sour, or stale flavour.

The present invention relates to a ready-to-use food composition comprising a mixture of at least one roasted cereal, a protein source, an oil blend, a milk product, sugar, a polysaccharide, a vitamin premix, a mineral premix and an emulsifier. In an embodiment, the invention provides a ready-to-use food composition wherein the mixture comprises roasted wheat flour, roasted semolina, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to food composition, wherein the mixture comprises:
Roasted Wheat Flour: 10 to 25% by wt.;
Roasted Semolina: 4 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1% by wt.;
Mineral Premix: 0.9 to 3.5% by wt.; and
Emulsifier: 0.5 to 2% by wt.

The invention also discloses a ready-to-use food composition comprising a mixture of a roasted oilseed, a roasted cereal, a cereal powder, a protein source, an oil blend, a milk product, sugar, a polysaccharide, a vitamin premix, a mineral premix and an emulsifier. In an embodiment, the invention provides a ready-to-use food food composition wherein the mixture comprises roasted sesame seeds, roasted millets, malt powder, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to-use food composition, wherein the mixture comprises:
Roasted Sesame Seeds: 5 to 15% by wt.;
Roasted Millets: 5 to 15% by wt.;
Malt Powder: 2 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

The invention further discloses a ready-to-use food composition comprising a mixture of a roasted legume, a roasted cereal, a protein source, an oil blend, a milk product, sugar, a polysaccharide, a vitamin premix, a mineral premix and an emulsifier. In an embodiment, the invention provides a ready-to-use food composition wherein the mixture comprises roasted pea, roasted corn flour, soy protein isolate—90%, non-hydrogenated vegetable oil blend, skimmed milk powder, icing sugar, maltodextrin, vitamin premix, mineral premix and an emulsifier.

In a preferred embodiment, the invention provides a ready-to-use food composition wherein the mixture comprises:
Roasted Pea: 10 to 25% by wt.;
Roasted Corn Flour: 4 to 10% by wt.;
Malt Powder: 2 to 10% by wt.;
Soy protein isolate—90%: 2 to 10% by wt.;
Skimmed Milk Powder: 15 to 35% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

In various embodiments, the ready-to-use food composition maintains the following chemical and nutritional composition per 100 gms:
Moisture content: 2.5% maximum
Water activity: 0.6 maximum
Energy: 520-550 kcal
Proteins: 10-12% total energy and 12.8-16.2% by weight
Lipids: 45-60% total energy and 25.8-36.3% by weight
n-6 fatty acids: 3-10% total energy
n-3 fatty acids: 0.3-2.5% total energy
Trans-fatty acids: <3% total fat
Fibre: <5%
Free sugar: <15%;

Further, the ready-to-use food composition maintains the following minerals and vitamins content per 100 gms.

The minerals include sodium 290 mg maximum, Potassium 1100-1400 mg, calcium 300-600 mg, phosphorous 300-600 mg, magnesium 80-140 mg, Iron 10-14 mg, zinc 11-14 mg, copper 1.4-1.8 mg, selenium: 20-40 mcg, and Iodine 70-140 mcg;

The vitamins includes Vitamin A (Retinol Equivalent) 0.8-1.1 mg, Vitamin B1(Thiamine) 0.5 mg minimum, Vitamin B2(Riboflavin) 1.6 mg minimum, Vitamin B3(Niacin) 5 mg minimum, Vitamin B5(Pantothenic acid) 3 mg minimum, Vitamin B6(Pyridoxine) 0.6 mg minimum, Vitamin B7(Biotin) 60 mcg minimum, Vitamin B9(Folic acid) 200 mcg minimum, Vitamin B12(Cyanocobalamin): 1.6 mcg minimum, Vitamin C(Ascorbic acid) 50 mg minimum; Vitamin D(Cholecalciferol): 15-20 mcg; Vitamin E(Tocopherol): 20 mg minimum; Vitamin K(Phytonadione): 15-30 mcg.

The present invention also provides a novel method of preparing the ready-to-use food compositions disclosed in the specification. The method is described below.

The first step is initiated by sorting of roasted raw materials such as wheat flour, semolina, dry pea, corn flour, hulled sesame seeds and millets. The roasted raw materials are thereafter milled to form a paste. The roasted raw material paste is then taken as per required weight for mixing cycle size.

In another step, non-hydrogenated vegetable oil is taken in an oil tank and heated. In a separate step, an emulsifier is taken in an emulsifier tank and allowed to heat and melt. Thereafter, the quantity of the emulsifier is taken as per mixing cycle size. In yet another step, total skimmed milk powder & soy protein isolate—90% quantity is weighed.

In a step, total sugar quantity is weighed. Thereafter, total maltodextrin and malt powder (if required in recipe) quantity is weighed. Further, in a step, the mineral premix quantity are vitamin premix are weighed.

Thereafter the roasted raw material paste is transferred in a blender for blending. During the blending process, non-hydrogenated vegetable oil and emulsifier are also transferred in the blender under mixing.

Further, mineral premix and/or vitamin premix and/or maltodextrin are added in the blender. Thereafter, the skimmed milk powder and soy protein isolate—90% trolley are transferred to the blender.

The contents in the blender are thereafter mixed. The mixing as described above, is allowed for another 30 min-35 min. in the blender.

Once the mixing is completed, the product is transferred in a holding tank and passed through a homogenizer for conducting the homogenization process. The homogenized product is thereafter transferred from the holding tank to a packaging machine hopper with the help of a pump after passing through a metal detector.

While considerable emphasis has been placed herein on the disclosed embodiments, it will be appreciated that changes can be made to the embodiments without departing from the principles of the present invention. These and other changes in the embodiments of the present invention shall be within the scope of the present invention and it is to be understood that the foregoing descriptive matter is illustrative and non-limiting.

We claim:

1. A ready-to-use food composition comprising a mixture of at least one roasted cereal, a protein source, an oil blend, a milk product, sugar, a polysaccharide, a vitamin premix, a mineral premix and an emulsifier.

2. A ready-to-use food composition as claimed in claim 1, wherein the mixture comprises roasted wheat flour, roasted semolina, soy protein isolate—90%, non-hydrogenated vegetable oil blend, skimmed milk powder, icing sugar, maltodextrin, vitamin premix, mineral premix and an emulsifier.

3. A ready-to-use food composition as claimed in claim 2, wherein the mixture comprises:
Roasted Wheat Flour: 10 to 25% by wt.;
Roasted Semolina: 4 to 10% by wt.;
Soy protein isolate—90%: 2 to 10% by wt.;
Skimmed Milk Powder: 15 to 30% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.5% by wt.;
Mineral Premix: 0.9 to 3.5% by wt.; and
Emulsifier: 0.5 to 2% by wt.

4. A ready-to-use food composition comprising a mixture of a roasted oilseed, a roasted cereal, a cereal powder, a protein source, an oil blend, a milk product, sugar, a polysaccharide, a vitamin premix, a mineral premix and an emulsifier.

5. A ready-to-use food composition as claimed in claim 4, wherein the mixture comprises roasted sesame seeds, roasted millets, malt powder, soy protein isolate—90%, non-hydrogenated vegetable oil blend, skimmed milk powder, icing sugar, maltodextrin, vitamin premix, mineral premix and an emulsifier.

6. A ready-to-use food composition as claimed in claim 5, wherein the mixture comprises:
Roasted Sesame Seeds: 5 to 15% by wt.;
Roasted Millets: 5 to 15% by wt.;
Malt Powder: 2 to 10% by wt.;
Soy protein isolate—90%: 2 to 10% by wt.;
Skimmed Milk Powder: 15 to 30% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

7. A ready-to-use food composition comprising a mixture of a roasted legume, a roasted cereal, a protein source, an oil blend, a milk product, sugar, a polysaccharide, a vitamin premix, a mineral premix and an emulsifier.

8. A ready-to-use food composition as claimed in claim 7, wherein the mixture comprises roasted pea, roasted corn flour, soy protein isolate—90%, non-hydrogenated vegetable oil blend, skimmed milk powder, icing sugar, maltodextrin, vitamin premix, mineral premix and an emulsifier.

9. A ready-to-use food composition as claimed in claim 8, wherein the mixture comprises:
Roasted Pea: 10 to 25% by wt.;
Roasted Corn Flour: 4 to 10% by wt.;
Malt Powder: 2 to 10% by wt.;
Soy protein isolate—90%: 2 to 10% by wt.;
Skimmed Milk Powder: 15 to 30% by wt.;
Icing Sugar: 10 to 20% by wt.;
Non-hydrogenated vegetable oil blend: 15 to 35% by wt.;
Maltodextrin: 2 to 10% by wt.;
Vitamin Premix: 0.1 to 1.0% by wt.;
Mineral Premix: 0.9 to 3.5% by wt.; and
Emulsifier: 0.5 to 2% by wt.

10. A ready-to-use food composition as claimed in any one of claims 1 to 9, wherein the chemical and nutritional composition of the food composition per 100 gms comprises:
Moisture content: 2.5% maximum
Water activity: 0.6 maximum
Energy: 520-550 kcal
Proteins: 10-12% total energy and 12.8-16.2% by weight
Lipids: 45-60% total energy and 25.8-36.3% by weight
n-6 fatty acids: 3-10% total energy
n-3 fatty acids: 0.3-2.5% total energy
Trans-fatty acids: <3% total fat
Fibre: <5%
Free sugar: <15%;
Minerals including: Sodium 290 mg maximum, Potassium 1100-1400 mg, Calcium 300-600 mg, Phosphorous 300-600 mg, Magnesium 80-140 mg, Iron 10-14 mg, Zinc 11-14 mg, Copper 1.4-1.8 mg, Selenium: 20-40 mcg, and Iodine 70-140 mcg;
Vitamins including: Vitamin A (Retinol Equivalent) 0.8-1.1 mg, Vitamin B1(Thiamine) 0.5 mg minimum, Vitamin B2(Riboflavin) 1.6 mg minimum, Vitamin B3(Niacin) 5 mg minimum, Vitamin B5(Pantothenic acid) 3 mg minimum, Vitamin B6(Pyridoxine) 0.6 mg minimum, Vitamin B7(Biotin) 60 mcg minimum, Vitamin B9(Folic acid) 200 mcg minimum, Vitamin B12(Cyanocobalamin): 1.6 mcg minimum, Vitamin C(Ascorbic acid) 50 mg minimum; Vitamin D(Cholecalciferol): 15-20 mcg; Vitamin E(Tocopherol): 20 mg minimum; Vitamin K(Phytonadione): 15-30 mcg.
